(19) United States
(12) Patent Application Publication
(10) Pub. No.: US 2016/0130887 A1
(43) Pub. Date: May 12, 2016

(54) STEM WEAR GUARD

(71) Applicant: SANDVIK INTELLECTUAL PROPERTY AB, Sandviken (SE)

(72) Inventors: Andrew BARNES, New South Wales (AU); Noel KIRBY, New South Wales (AU)

(21) Appl. No.: 14/895,600

(22) PCT Filed: Jun. 6, 2014
(86) PCT No.: PCT/IB2014/062018

§ 371 Date: Dec. 3, 2015

Related U.S. Application Data
(60) Provisional application No. 61/832,552, filed on Jun. 7, 2013.

(51) Int. Cl. E21B 17/10; B29C 65/02; B29C 65/48

(52) U.S. Cl. CPC E21B 17/1085; B29C 65/48; B29C 65/02; B29L 2031/768

(57) ABSTRACT

A stem guard for a stem of a raise bore drill includes at least one wear pad attachable to the device. At least one volume of wear resistant material is joined with the at least one wear pad to form a wear pad assembly. The wear pad assembly is fixedly secured to the stem. A method of forming a wear pad assembly for protecting a device includes the steps of providing at least one volume of wear resistant material. The at least one volume of wear resistant material is joined to a protective material to form at least one wear pad assembly. At least one wear pad assembly is attached to the device and the at least one wear pad assembly is fixed to the device to protect the same from wear.

### TECHNICAL FIELD

The present disclosure relates to a stem guard having at least one wear pad assembly fixed to a stem thereof and a method of forming the at least one wear pad assembly.

### BACKGROUND

It is known to provide wear protection to the stem of a raise bore drill via either a weld-on pad or channels machined in an axial direction into the shaft, which is then back filled with hard face weld or granular carbide weld, see FIG. 1. Such current stem wear protection methods all use excessive localized heat in the manufacturing process. This localized heat introduces high heat levels compromising the stem's integrity causing premature failure. Also, previous trials of pressing cemented carbide buttons onto the stem, similar to ‘down the hole’ exploration drill heads, have failed due to the flexing of the shaft subsequently opening the drilled hole, allowing the buttons to fall out.

### SUMMARY

In one embodiment, a stem guard for a raise bore drill includes at least one wear pad assembly fixed to a stem of the drill, the at least one wear pad assembly including at least one volume of wear resistant material fixed to the at least one wear pad.

In another embodiment, a method of forming a wear pad assembly for protecting a device includes the steps of providing at least one volume of wear resistant material. The at least one volume of wear resistant material is joined to a protective material to form at least one wear pad assembly. At least one wear pad assembly is attached to the device and the at least one wear pad assembly is fixed to the device to protect the same from wear.

The foregoing summary, as well as the following detailed description of the embodiments, will be better understood when read in conjunction with the appended drawings. It should be understood that the embodiments depicted are not limited to the precise arrangements and instrumentalities shown.

### BRIEF DESCRIPTION OF THE DRAWINGS

FIG. 1 is a perspective view of a known raise bore drill.

FIG. 2 is a perspective view of an embodiment of a stem guard for a raise bore drill.

FIG. 3 is a top view of the stem guard of FIG. 2.

FIG. 4 is a cross-sectional view taken along line I-I of FIG. 3.

FIG. 5 is an enlarged view of section B of FIG. 4.

FIG. 6 is a cross-sectional view taken along line II-II of FIG. 3.

FIG. 7 is an enlarged view of section D of FIG. 6.

FIG. 8 is a top view of another embodiment of a stem guard.

FIG. 9 is a top view of a wear pad assembly of the stem guard.

FIG. 10 is a cross-sectional view taken along line of FIG. 9.

FIG. 11 is a cross-sectional view taken along line IV-IV of FIG. 9.

FIG. 12 is a flow diagram of a method of a present embodiment.

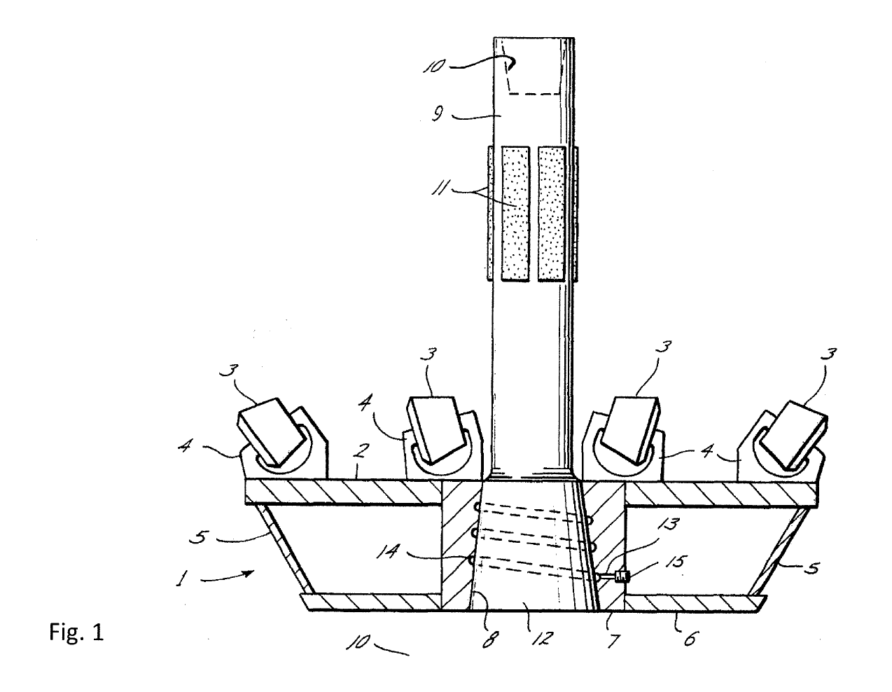

### DETAILED DESCRIPTION

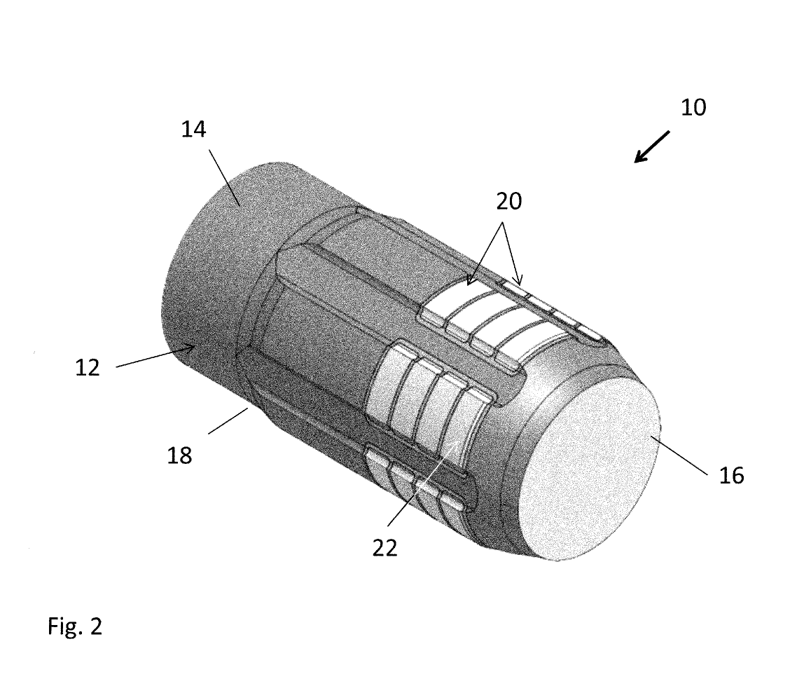

Referring to FIG. 2, a device 10, which can be a raise bore drill or any other device having a protectable portion, is shown. The drill has a drive stem 12. Stem 12 has a tapered threaded opening at its upper end 14 to provide a threaded connection to a drill pipe (not shown). The stem acts as a stabilizing unit to which a cutter assembly (not shown) can be mounted on its lower end 16. The stem can be made from steel, for example, KSA30 (modified AISI: 4340), which is specified to not be exposed to any localized heating, such as welding.

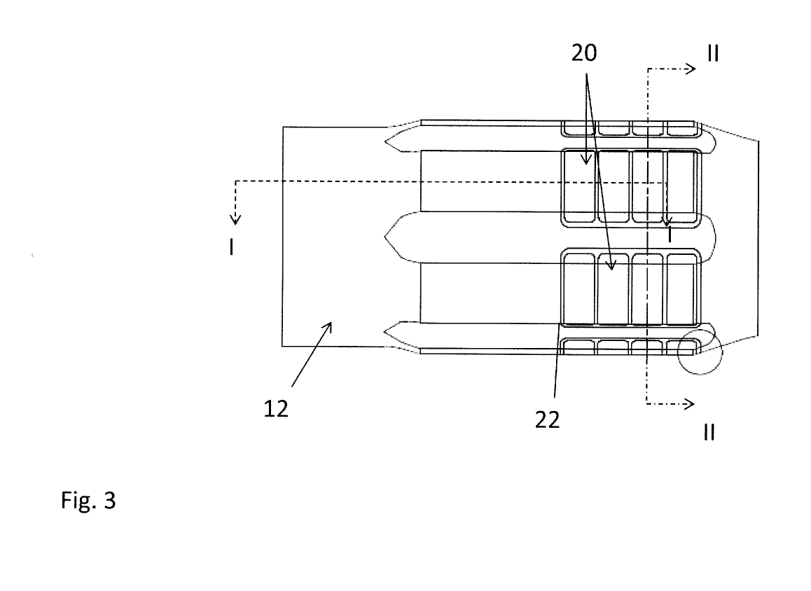

Stem 12 has an axial length 18 and a plurality of wear pad assemblies 20 extending along axial length 18 and spaced circumferentially about the stem. As shown in FIGS. 2 and 3, stem 12 includes a plurality of cavities 22 for receiving a plurality of wear pad assemblies 20.

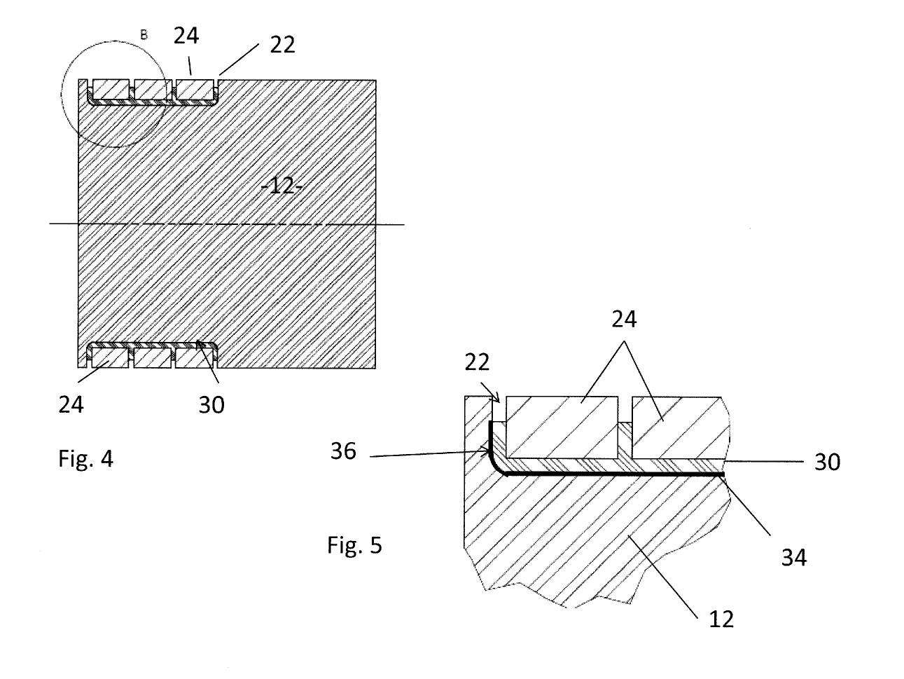

Referring to FIGS. 4 and 5, each wear pad assembly 20 includes at least one volume of wear resistant material 24 fixed to a wear pad 30. Wear resistant material 24 can be cemented carbide, for example, tungsten carbide or a ceramic. Also, wear resistant material 24 can be a combination of rubber and cemented carbide or other material. Also, a composite of cemented carbide bonded by a casting method with ferrous metals, such as steel, white iron, etc. The wear resistant material provides the benefits of improved wear life, impact resistance, depending on the material grade, and rigidity to the assembly. It should be appreciated that other wear resistant materials can be used.

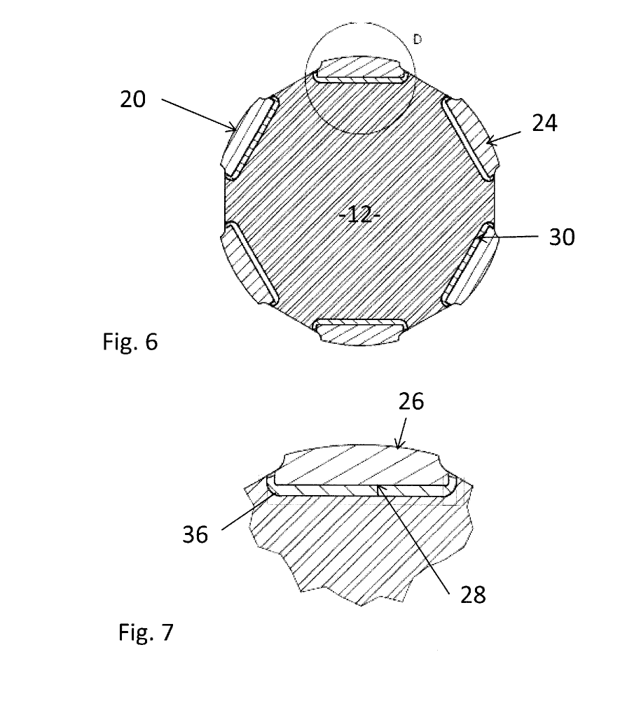

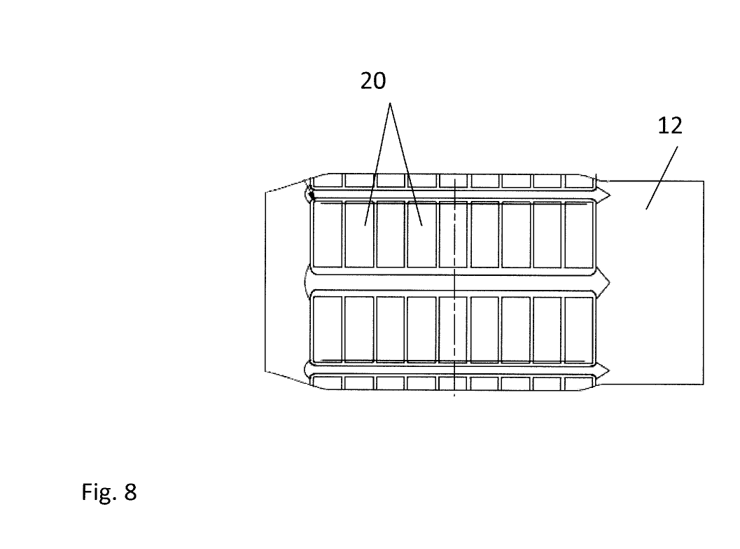

As shown in FIGS. 6 and 7, wear pad 30 is attachable to stem 12 and receives at least one volume of wear resistant material 24. As shown in FIG. 8, a plurality of volumes of wear resistant material 24 can be fixed to a single wear pad. It also should be appreciated that each volume of wear resistant material 24 could be attached to a single wear pad.

Wear pad 30 is made of a protective material, such as rubber, neoprene, polymers or synthetic rubber. Pad 30 is joined to the stabilizing stem to prevent diameter wear of the stem and to assist with stabilizing the raise bore cutting head (not shown) as it is raised.

The neoprene and other flexible, protective material is used is due to its bonding method, impact absorbing properties and energy dispersion during impact and shaft flex/movement, hence reducing energy from stress to the cemented carbide components. The pad allows some give, thereby limiting risk of carbide fracture.

Wear pad assembly 20 is manufactured prior to bonding to the stem. Assembly 20 includes the neoprene or rubber pad 30 that has cemented carbide components molded into the same, which will be described further herein. Pad 30 can have a thickness of 20 to 200 mm.

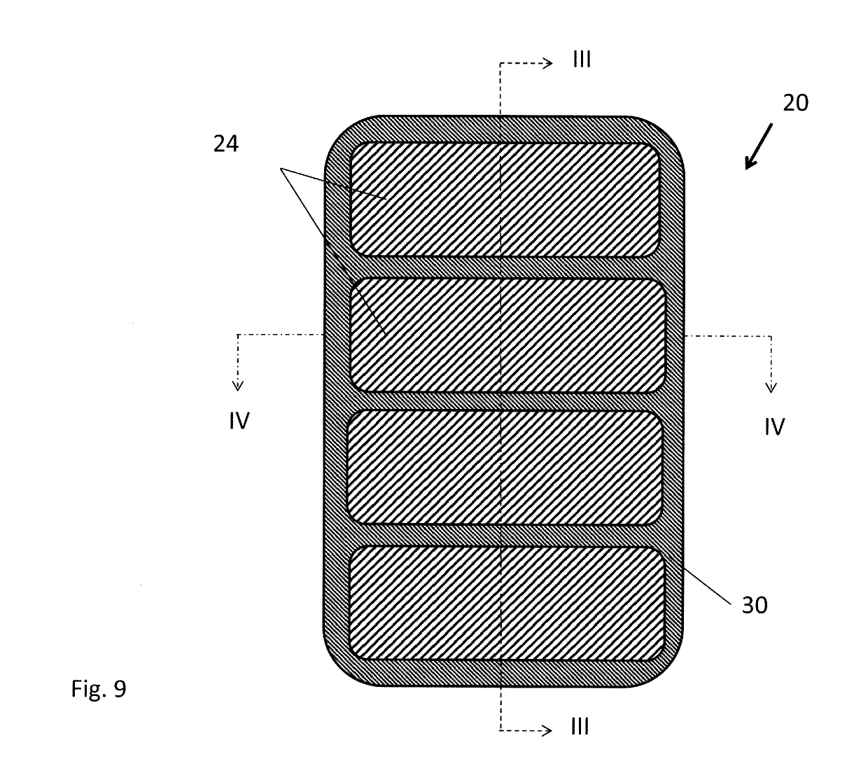

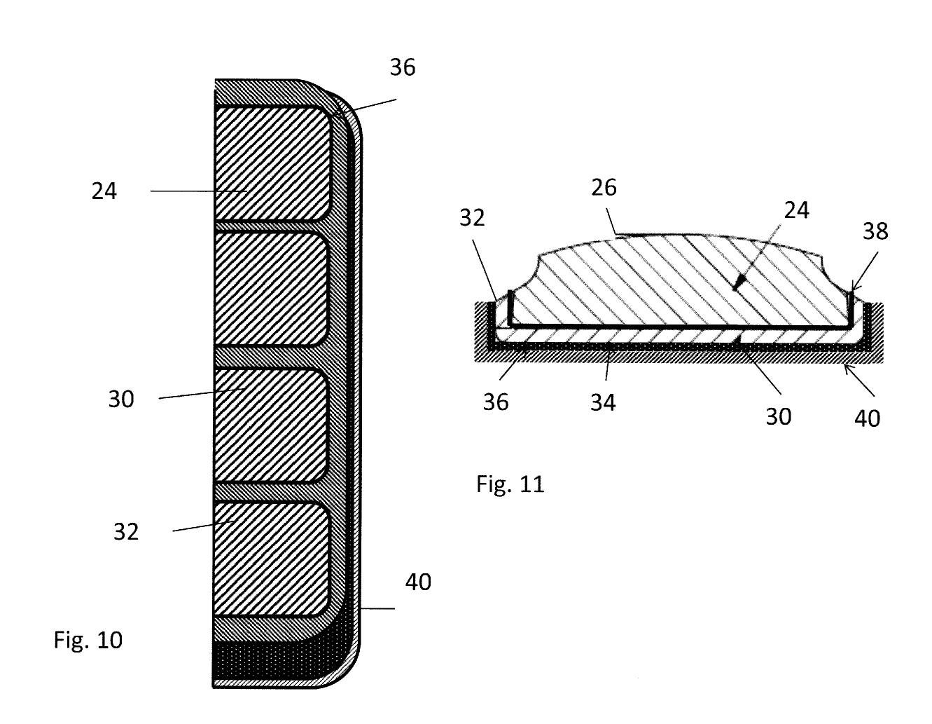

As shown in FIGS. 9-11, cemented carbide component 24 has an upper surface 26 and a lower surface 28. Referring again to FIGS. 5-7, upper surface 26 is positioned to be exposed to the bore hole. As will be described further herein, lower surface 28 is attached to wear pad 30 at a top side 32 thereof.

A layer of material 36, for example, uncured rubber can be fixed to a bottom side 34 of wear pad 30. This layer 36 assists with the bonding technology of the neoprene to the stem's steel surface.

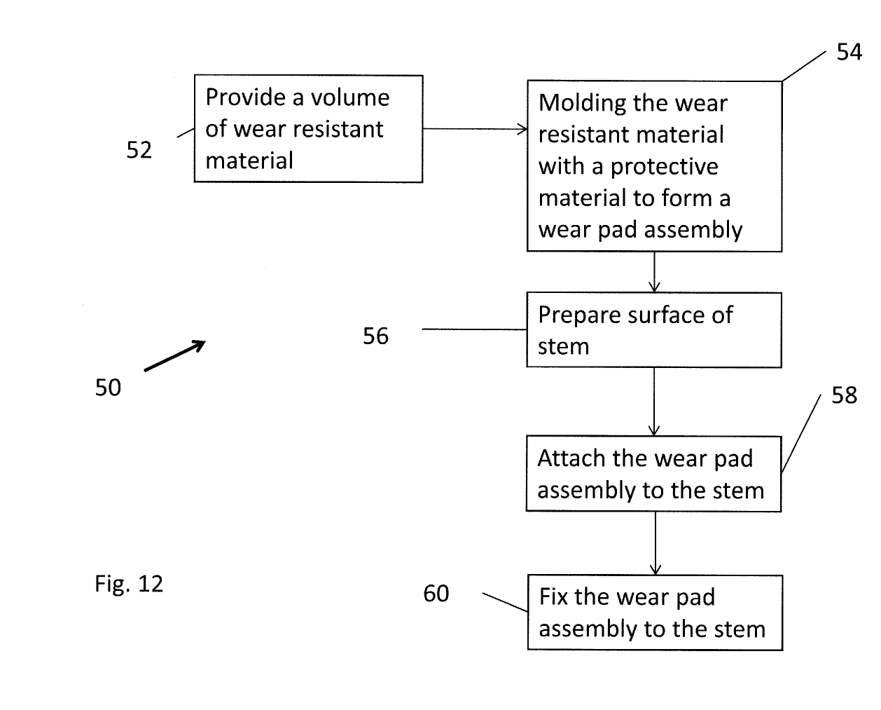

Referring to FIG. 12, a method 50 of forming a wear pad assembly for protecting a device is shown. The wear pad assembly is formed by providing a volume of wear resistant material, for example, cemented carbide in step 52. The cement carbide is grit blasted and cleaned to degrease the same. A layer of adhesive primer, such as Chemlock 205 (Lord Corp, Cary, N.C.), is then applied followed by a layer of adhesive 38, Chemlock 220 (Lord Corp, Cary, N.C.).

In next step 54, wear resistant material 24 is joined to wear pad 30 by chemically bonding it to wear pad 30 or vulcanized by placing the adhesive coated cemented carbide component into a mold, and then adding neoprene or rubber beads to the mold. The cemented carbide and neoprene is then hot pressed to mold the assembled pad. It should be appreciated that a number of cemented carbide components can be molded with a singular wear pad. However, single cemented carbide could be molded with a wear pad. Wear pad 30 can also be applied with layer 36 of uncured rubber.

In step 56, cavities 22 of stem 12 are prepared to receive the wear pad assemblies. The surface of the stem cavities are prepared by grit blasting and degreasing. A layer of adhesive primer, such Chemlock 205 (Lord Corp, Cary, N.C.), is applied. In preparation for the molded wear pad assembly attachment, a layer of adhesive 40, Chemlock 220 (Lord Corp, Cary, N.C.), is then applied to the cavity surface or the lower surface of wear pad 30.

Wear pad assembly 20 is attached to the device in step 58 by inserting a wear pad assembly in each of the cavities. Thereafter, the attached wear pad assemblies are compressed to secure the same to the stem, for example, by wrapping the stem and wear pad assemblies in a material, such as nylon.

In step 60, the wear pad assemblies are fixedly secured to the stem by subjecting the same to a low pressure, low temperature condition. For example, a temperature from about 50 to about 350° C. and a pressure of about 1 to about 15 atmospheres to finish the process of attaching the stem guard to the stem.

By using a product that requires low/zero heat to attach the wear protection, the overall life of the stem is improved. Also, by incorporating cemented carbide into the assembly, further wear improvement properties are achieved.

Although the present embodiments have been described in relation to particular aspects thereof, many other variations and modifications and other uses will become apparent to those skilled in the art. It is preferred therefore, that the present disclosure be limited not by the specific embodiments herein, but only by the appended claims.

1. A method of forming a wear pad assembly for protecting a device comprising the steps of:
providing at least one volume of wear resistant material;
joining the at least one volume of wear resistant material to a protective material to form at least one wear pad assembly;
attaching the at least one wear pad assembly to the device; and
fixing the at least one wear pad assembly to the device to protect the same from wear.

2. The method according to claim 1, wherein the volume of wear resistant material is selected from the group of cemented carbide, ceramic, or other materials and a combination thereof.

3. The method according to claim 2, wherein the cemented carbide is tungsten carbide.

4. The method according to claim 1, wherein the volume of wear resistant material is coated with adhesive prior to joining.

5. The method according to claim 1, wherein the protective material is selected from the group of rubber, neoprene, polymers or synthetic rubber.

6. The method according to claim 1, wherein the protective material has a thickness of about 20 to about 200 mm.

7. The method according to claim 1, wherein the step of joining comprises inserting the volume of wear resistant material and protective material into a mold and hot pressing to form an assembled wear pad.

8. The method according to claim 1, wherein the step of joining comprises chemically bonding the volume of wear resistant material and protective material.

9. The method according to claim 1, wherein a plurality of volumes of wear resistant material are fixed on the at least one wear pad.

10. The method according to claim 1, wherein the step of fixing the at least one wear pad assembly to the device comprises fixing a plurality of wear pad assemblies to the device.

11. The method according to claim 1, wherein a layer of uncured rubber is applied on an underside of the at least one wear pad prior to attaching at the at least one wear pad assembly to the device.

12. The method according to claim 1, wherein the device is coated with a coating of adhesive prior to attaching the at least one wear pad assembly to the device.

13. The method according to claim 1, wherein the step of fixing the at least one wear pad assembly comprises subjecting the device and attached at least one wear pad assembly to a temperature of 50-350° C. and a pressure of 1-15 atmospheres.

14. A stem guard for a device comprising at least one wear guard assembly made according to the method of claim 1.

15. The stem guard according to claim 14, wherein the device is a raise bore drill having a stem, the at least one wear pad being fixed to the stem.

16. (canceled)

17. (canceled)
